(19) United States
(12) Patent Application Publication
(10) Pub. No.: US 2014/0132806 A1
(43) Pub. Date: May 15, 2014

(54) IMAGE PROCESSING APPARATUS, IMAGING APPARATUS, IMAGE PROCESSING METHOD AND PROGRAM

(71) Applicant: Sony Corporation, Tokyo (JP)

(72) Inventors: Manabu Hara, Tokyo (JP); Ken Nakajima, Tokyo (JP)

(73) Assignee: Sony Corporation, Tokyo (JP)

(21) Appl. No.: 14/073,540

(22) Filed: Nov. 6, 2013

(30) Foreign Application Priority Data
Nov. 13, 2012 (JP) 2012-249557

(51) Int. Cl. H04N 5/232; G06T 5/00

(52) U.S. Cl. CPC H04N 5/23229; G06T 5/001
USPC 348/241; 382/275

(57) ABSTRACT

There is provided an image processing apparatus including a horizontal distortion correction processing part configured to perform a distortion correction processing in a horizontal direction on an input image depending on a synchronization signal that is supplied, a memory configured to sequentially store results of the distortion correction processing in the horizontal direction by the horizontal distortion correction processing part, and a vertical distortion correction processing part configured to, after starting the distortion correction processing in the horizontal direction by the horizontal distortion correction processing part, sequentially read out the results of the distortion correction processing in the horizontal direction from the memory with a delay of a predetermined time period less than one frame to start a distortion correction processing in a vertical direction.

### CROSS REFERENCE TO RELATED APPLICATIONS

This application claims the benefit of Japanese Priority Patent Application JP 2012-249557 filed Nov. 13, 2012, the entire content of which is incorporated herein by reference.

### BACKGROUND

The present disclosure relates to an image processing apparatus, an imaging apparatus, an image processing method and a program applied to a video camera, digital still camera and the like.

In related art, distortion has occurred in an image picked up by the video camera or digital still camera or a silver salt camera due to distortion aberration characteristics of an imaging lens. In addition, a CMOS (Complementary Metal Oxide Semiconductor) image sensor accumulates and reads out signal charge by a rolling shutter system, disadvantageously distorting the image if a subject moves at a high speed.

Typically, in the case of performing a distortion correction processing in a vertical direction on an input image, when a filter having a large number of taps is used and an image is large in amount of movement in the vertical direction, a large amount of data is processed and thus a frame memory is used.

Hereafter, a distortion correction processing of related art is described with reference to the drawings. FIG. 1 is an illustration diagram of a distortion correction processing of related art.

A distortion correcting circuit of related art refers to a distortion correction table for an input image 200 from a top row to a bottom row thereof to perform the distortion correction processing (raster processing) in a horizontal direction, and accumulates the result therefrom in a frame memory. Then, after obtaining the distortion correction result in the horizontal direction on an image of one frame, the circuit sequentially reads out the image from the top row to the bottom row thereof in the vertical direction and refers to the distortion correction table to correct the distortion in the vertical direction. At this time, one row of pixel row is divided into parts each having a predetermined number of pixels, and in a unit of the predetermined number of pixels a distortion correction processing (strip processing) is performed in vertical direction, for example.

FIG. 2 is a timing chart of the distortion correction processing shown in FIG. 1.

Exposure of the image sensor is performed depending on a synchronization signal (2-1) for an image sensor with a period of 1/60 second per cycle. Also, a CPU (Central Processing Unit) not shown acquires lens information (table used for distortion correction) of an imaging lens (2-2). In an example shown in FIG. 2, time periods associated with first to third images sequentially output from the image sensor are represented by (1), (2), and (3), respectively.

After the exposure of the image sensor and the lens information acquisition by the CPU, the distortion correcting circuit, depending on a synchronization signal (2-3) for distortion correction processing in the horizontal direction, receives from the CPU and sets distortion correction data for horizontal distortion correction processing (2-4). Hereinafter, the distortion correction processing in the horizontal direction may be referred to as a “horizontal distortion correction processing”. After that, an image is output from the image sensor, which image is sequentially subjected to the horizontal distortion correction processing (2-5), and the image subjected to the horizontal distortion correction processing (hereafter, referred to as a “horizontal-corrected image”) is written into the memory (2-6).

After completion of the horizontal distortion correction processing, depending on a synchronization signal (2-7) for distortion correction processing in the vertical direction, the distortion correcting circuit receives from the CPU and sets distortion correction data for vertical distortion correction processing (2-8). Hereinafter, the distortion correction processing in the vertical direction may be referred to as “vertical distortion correction processing”. After that, depending on the synchronization signal for vertical distortion correction processing, the vertical distortion correction processing is performed such that the image subjected to the horizontal distortion correction is read out from the top row to the bottom row in the vertical direction from the memory (2-9). Then, the image subjected to the vertical distortion correction processing (corrected image) is written into the memory (2-10).

After that, the distortion correcting circuit reads out the corrected image from the memory depending on the synchronization signal for vertical distortion correction processing, and outputs the read image to the outside (2-11).

For example, Japanese Patent Laid-Open No. 2004-80545 has proposed an image processing apparatus that the distortion correction processing in the vertical direction is performed after the distortion correction processing in the horizontal direction. The image processing apparatus described in this patent document uses a horizontal one-dimensional interpolating part to perform a one-dimensional interpolating operation using horizontal correction parameter indicating a correction amount in the horizontal direction at pixel points constituting an original image which has distortion, and thereby correct the distortion in the horizontal direction. Further, the image processing apparatus performs a one-dimensional interpolating operation on the image obtained by the correction in the horizontal direction using a vertical correction parameter indicating a correction amount in the vertical direction at the pixel points constituting the relevant original image, thereby corrects the distortion of the original image in the vertical direction.

### SUMMARY

However, since the method above performs the vertical distortion correction processing after completion of the horizontal distortion correction processing on all the rows of the image, delay of two frames is generated from the start of the time period of the horizontal distortion correction processing until the vertical distortion correction processing is completed to obtain the corrected image, as shown in FIG. 2. Such a delay is not preferable in a high performance video camera for sports relay with low processing delay being demanded, a security camera applied for monitoring danger and the like.

The above situation has demanded an approach in order to decrease the delay generated from the start of the time period of the distortion correction processing in the horizontal direction on an input image until a final corrected image is obtained.

According to an embodiment of the present disclosure, a horizontal distortion correction processing part performs a distortion correction processing in the horizontal direction on an input image depending on a synchronization signal supplied, and a result to the distortion correction processing in the horizontal direction by the horizontal distortion correction processing part is sequentially stored in a memory. Next, a vertical distortion correction processing part, after starting the distortion correction processing in the horizontal direction by the horizontal distortion correction processing part, sequentially reads out the result of the distortion correction processing in the horizontal direction from the memory with being delayed by a predetermined time period less than one frame to start the distortion correction processing in the vertical direction.

According to a configuration of the present disclosure, the vertical distortion correction processing can be started before the completion of the horizontal distortion correction processing on the entire input image. As a result, it is possible as compared with the related art to decrease a delay generated from the start of a time period of the horizontal distortion correction processing until the vertical distortion correction processing is completed to obtain a corrected image.

According to an embodiment of the present disclosure, it is possible decrease a delay generated from the start of the time period of the distortion correction processing in the horizontal direction until a final corrected image is obtained.

### BRIEF DESCRIPTION OF THE DRAWINGS

FIG. 1 is an illustration diagram of a distortion correction processing of related art;

FIG. 2 is a timing chart of the distortion correction processing shown in FIG. 1;

FIG. 3 is an illustration diagram of a distortion correction processing according to one embodiment of the present disclosure, and FIG. 3A is an illustration diagram of the distortion correction processing on an input image for an upper half thereof and FIG. 3B is an illustration diagram of the distortion correction processing on an input image for a lower half thereof;

FIG. 4 is an illustration diagram of a correction processing input image and a correction processing output image in the distortion correction processing according to one embodiment of the present disclosure, and FIG. 4A is an illustration diagram in the distortion correction processing on an input image for an upper half thereof and FIG. 4B is an illustration diagram in the distortion correction processing on the input image for a lower half thereof;

FIG. 5 is a block diagram showing an example internal configuration of an imaging apparatus according to one embodiment of the present disclosure;

FIG. 6 is a block diagram showing an example internal configuration of a distortion correction processing part in the imaging apparatus shown in FIG. 5;

FIG. 7 is a flowchart showing a distortion correction processing according to one embodiment of the present disclosure;

FIG. 8 is a timing chart of a distortion correction processing according to one embodiment of the present disclosure; and

FIG. 9 is a block diagram showing an example hardware configuration of a computer.

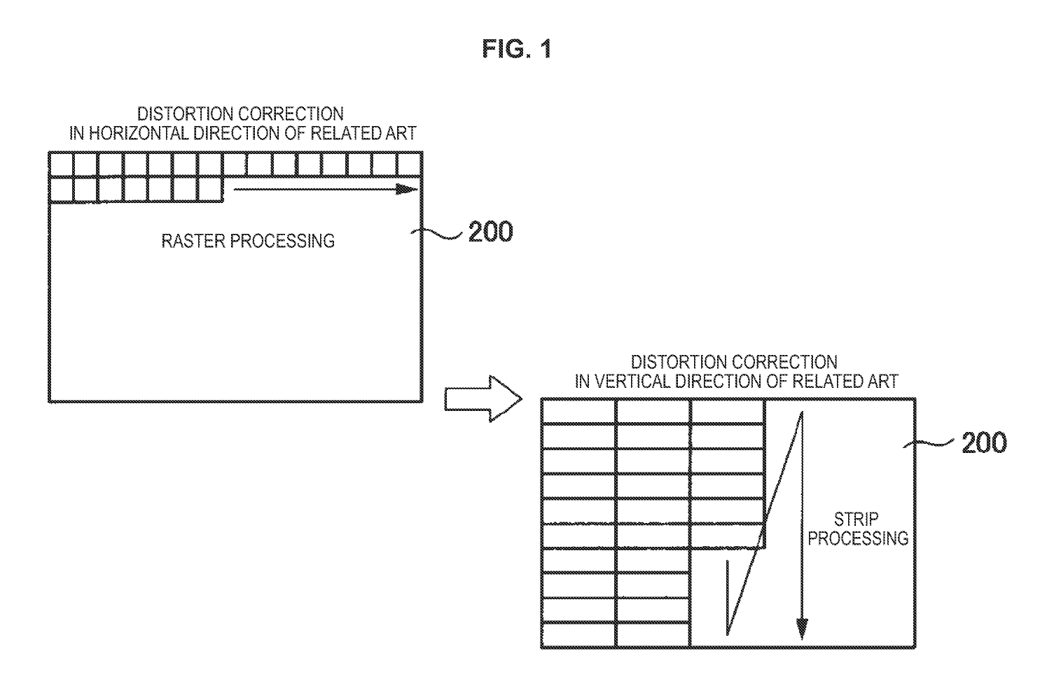

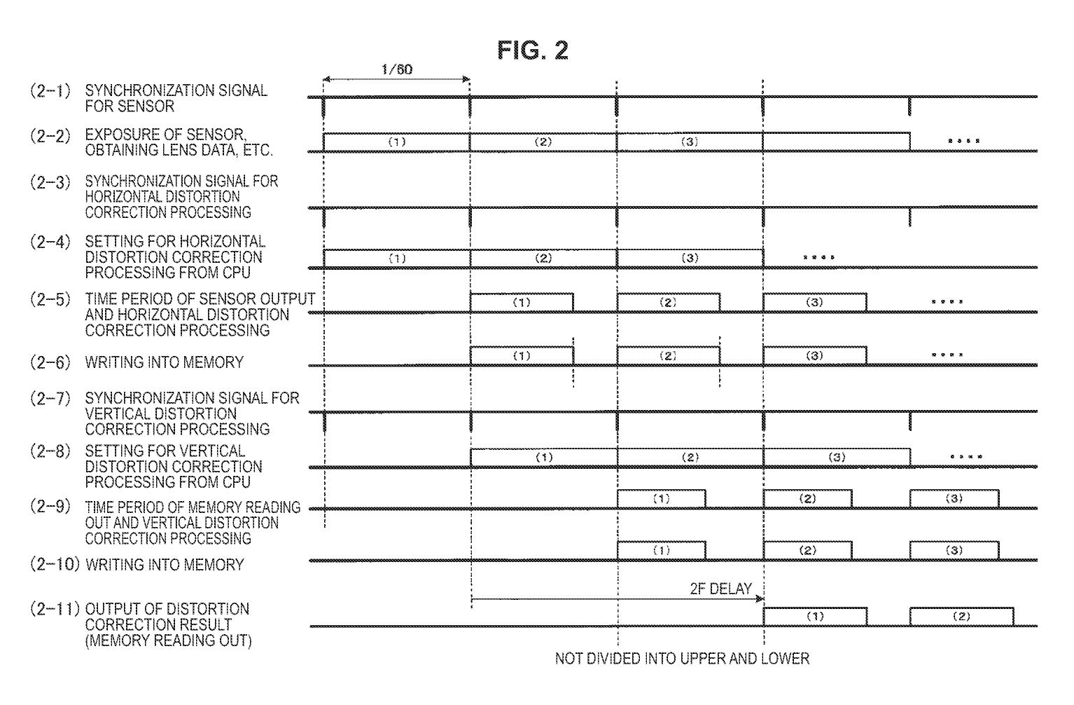

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted. The description will proceed in the following order.

1. One embodiment (example in which an image is divided into a plurality of regions and start a vertical distortion correction processing from a region where a horizontal distortion correction processing is completed)

2. Others (modified examples)

### <1. One Embodiment> [overview]

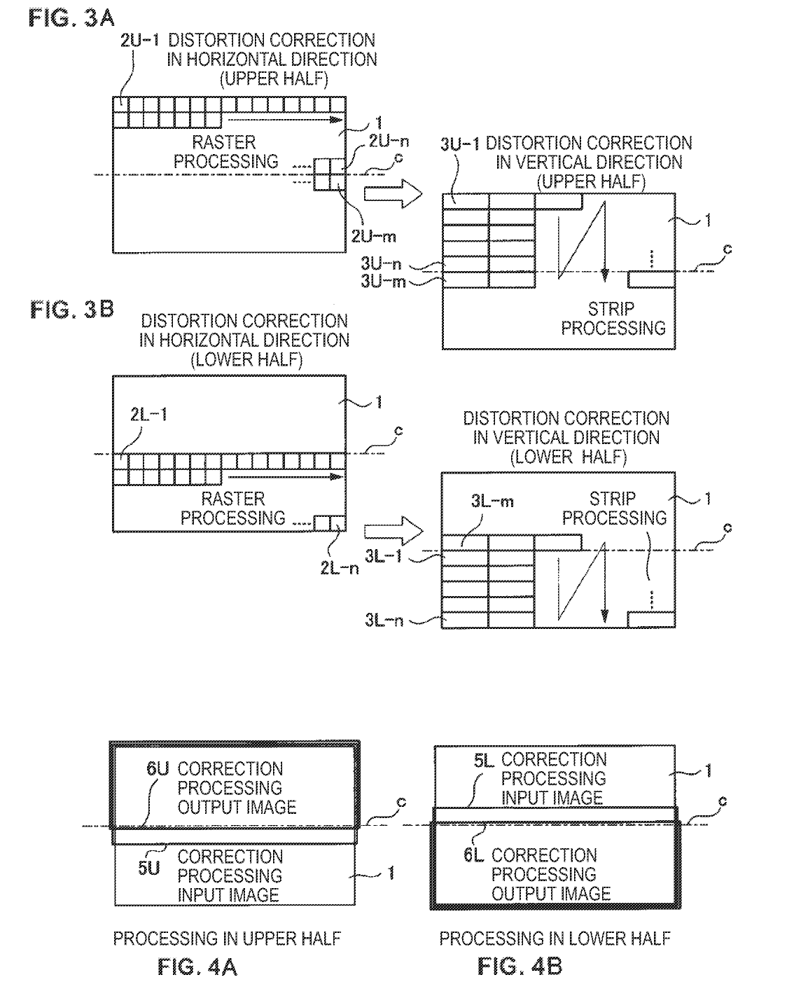

A description will be given of an overview of a distortion correction processing according to one embodiment of the present disclosure with reference to FIG. 3 and FIG. 4.

FIG. 3 is an illustration diagram of the distortion correction processing according to one embodiment of the present disclosure, and FIG. 3A is an illustration diagram of the distortion correction processing on an input image for an upper half thereof and FIG. 3B is an illustration diagram of the distortion correction processing on an input image for a lower half thereof.

FIG. 4 is an illustration diagram of a correction processing input image and a correction processing output image in the distortion correction processing according to one embodiment of the present disclosure, and FIG. 4A is an illustration diagram in the distortion correction processing on an input image for an upper half thereof and FIG. 4B is an illustration diagram in the distortion correction processing on the input image for a lower half thereof.

In the present disclosure, after completion of the distortion correction processing in the horizontal direction on the input image, the distortion correction processing in the vertical direction is performed with being delayed by a predetermined time period less than one frame. As an example, after the completion of the distortion correction processing in the horizontal direction on one region of a plurality of regions which are obtained by dividing in the vertical direction an image to be corrected, the distortion correction processing in the vertical direction is started on the one region. FIG. 3 and FIG. 4 show an example in which an input image 1 is divided into upper and lower two regions (in the vertical direction) at a center line c, on each region of which the distortion correction processing is performed in the horizontal direction and the vertical direction.

First, the distortion correction processing in the horizontal direction (raster processing) is performed on the image 1 to be corrected from a top row 2U-1 to a bottom row 2L-n, and a result thereof is accumulated in a memory 50 described later. Then, during the distortion correction processing on the above image 1 in the horizontal direction, at the completion of the distortion correction processing in the horizontal direction on a first region as the upper half of the image, the distortion correction processing in the vertical direction is started on the first region.

Here, at the completion of the distortion correction processing in the horizontal direction on the first region of the image 1 from the top row 2U-1 to a bottom row 2U-n as well as on a row 2U-m which is lower than the bottom row 2U-n by one row, the distortion correction processing in the vertical direction is started on the first region. The row 2U-m corresponds to a top row 2L-1 in a second region as the lower half of the image 1.

In the distortion correction processing in the vertical direction, one row of pixel row is divided by a unit of a predetermined number of pixels (pixel group), and the distortion correction processing (strip processing) is sequentially performed in a unit of this pixel group from a leftmost column in the vertical direction. In other words, the distortion correction processing in the vertical direction is performed from a pixel group 3U-1 to a pixel group 3U-n and a pixel group 3U-m, the pixel group 3U-1 being leftmost in the first region of the image 1 and in the top row 2U-1 in the first region, the a pixel group 3U-n being in the bottom row 2U-n in the first region and the pixel group 3U-m being in a row 2U-m lower than the row 2U-n by one row. This distortion correction processing in the vertical direction is sequentially performed on the first region from a pixel group at the leftmost column to a pixel group at a rightmost column.

Similarly, at the completion of the distortion correction processing in the horizontal direction on the second region as the lower half of the image 1, the distortion correction processing in the vertical direction is started on the second region. In other words, the distortion correction processing in the horizontal direction is sequentially performed from the top row 2L-1 in the second region of the image 1 to the bottom row 2L-n in the second region, and at the completion of the distortion correction processing in the horizontal direction on the bottom row 2L-n, the distortion correction processing in the vertical direction is started on the second region. Then, the distortion correction processing in the vertical direction is performed on the pixel group 3L-m and from a pixel group 3L-1 to the pixel group 3L-n, the pixel group 3L-m being leftmost in the second region of the image 1 and in the row 2U-n upper than the top row 2L-1 by one row in the second region, the pixel group 3L-1 being in the top row 2L-1 in the second region, and the pixel group 3L-n being in the bottom row 2L-n in the second region. This distortion correction processing in the vertical direction is sequentially performed on the second region from a pixel group at the leftmost column to a pixel group at the rightmost column.

As described above, in the distortion correction processing for the first region of the image 1 (upper side), the distortion correction processings in the horizontal direction and the vertical direction are performed on the first region and a correction processing input image 5U which belongs to the second region (lower side) and includes the row 2U-m continuous to the first region. Then, the row 2U-m extensionally processed is eliminated from a correction processing output image 6U to be output (FIG. 4A).

Similarly, in distortion correction processing for the second region, the distortion correction processings in the horizontal direction and the vertical direction are performed on the second region and a correction processing input image 5L which belongs to the first region (lower side) and includes the row 2U-n continuous to the second region. Then, the row 2U-n extensionally processed is eliminated from a correction processing output image 6L to be output (FIG. 4B).

This makes it possible to maintain continuity of distortion correction results in the vicinity of the center line c between the first region and the second region of the image 1, obtaining a high-quality corrected image. Here, such a difference between the correction processing input image and the correction processing output image is preferably adjusted adequately in accordance with a magnitude of the distortion (distortion characteristics of the imaging lens), accuracy of the distortion or the like.

In other words, in the present disclosure, first, the distortion correction processing in the horizontal direction is performed on the plurality of regions obtained by dividing the input image. Next, besides one region subjected to the distortion correction processing in the horizontal direction (e.g., the first region), the distortion correction processing in the vertical direction is performed for a predetermined number of horizontal lines included in a region which is continuous to the one region and adjacent to the one region (e.g., the second region). Then, only one region of the input image subjected to the distortion correction processing in the vertical direction is output as the corrected image. This makes it possible to maintain continuity of the distortion correction results in the vicinity of a dividing line (e.g., the center line c) between the regions adjacent to each other.

### [Imaging Apparatus]

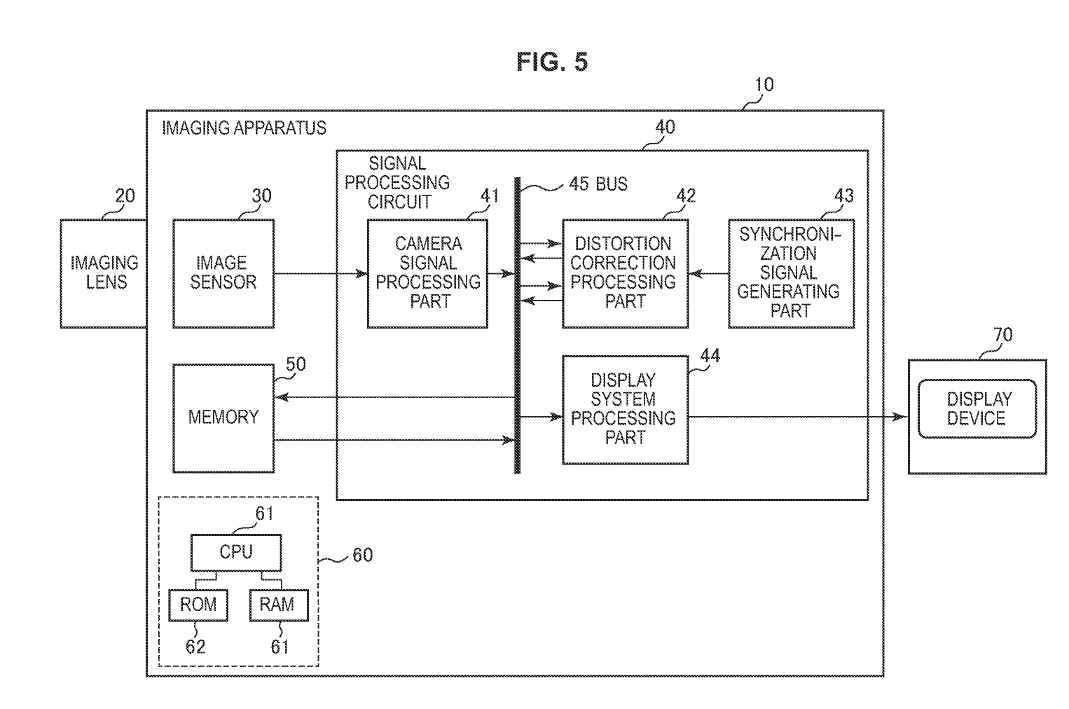

Next, a description will be given of an example configuration of an imaging apparatus as one example of the image processing apparatus with reference to FIG. 5.

FIG. 5 is a block diagram showing an example internal configuration of an imaging apparatus 10 according to one embodiment of the present disclosure. The imaging apparatus 10 includes an image sensor 30, a signal processing circuit 40, a memory 50, and a controlling part 60.

The image sensor 30 is an imaging device to which a CCD (Charge Coupled Devices), a CMOS image sensor and the like are applied. A sequential readout processing is performed in a unit of region depending on a predetermined shutter operation, a unit of row, for example. The image sensor 30 accumulates a charge using a photo diode of each pixel in an effective imaging region on the basis of a synchronization signal of a main body of the imaging apparatus 10 depending on a light incident via the imaging lens 20, and outputs an analog photoelectric conversion signal based on the accumulated charge. The analog photoelectric conversion signal is converted to a digital signal by an A/D converter not shown to be supplied as a video signal (image) to the signal processing circuit 40. Here, the image sensor 30 may be configured to perform an analog/digital conversion processing on the photoelectric conversion signal.

The signal processing circuit 40 performs a signal processing such as the distortion correction processing on the video signal (image) supplied from the image sensor 30 to output the processed signal to the outside.

The signal processing circuit 40 includes blocks of a camera signal processing part 41, a distortion correction processing part 42, a synchronization signal generating part 43, and a display system processing part 44, and respective blocks are connected with each other via a bus 45 in a manner enabling data communication.

The camera signal processing part 41 performs, for example, on the video signal (image) supplied from the image sensor 30 a processing such as a pixel defect correction, shading correction, white balance adjustment, knee correction, gamma correction and the like to generate and output an output image. Typically, a bit wide (dynamic range) is compressed after the knee correction, gamma correction and the like, and thus the distortion correction processing using these correction results may suppress a circuit to a small size.

The distortion correction processing part 42 performs a processing to correct a distortion of the image due to the video signal input from the camera signal processing part 41. This processing will be described in detail later.

The synchronization signal generating part 43 generates a synchronization signal used for controlling each block or signal processing in the signal processing circuit 40 in accordance with a clock signal supplied from the outside. The synchronization signal generating part 43 supplies the generated synchronization signal to the distortion correction processing part 42.

The display system processing part 44 converts the video signal subjected to the distortion correction processing in the distortion correction processing part 42 or the video signal stored in memory 50 into a final video output format to output to a display device 70. For example, the display system processing part 44 includes a matrix circuit to convert color data of red, green, and blue contained in the video signal into a format of a luminance signal Y, red chrominance signal Cr, and blue chrominance signal Cb to output to the display device 70. As the display device 70, a crystal display device, organic EL display device and the like are used.

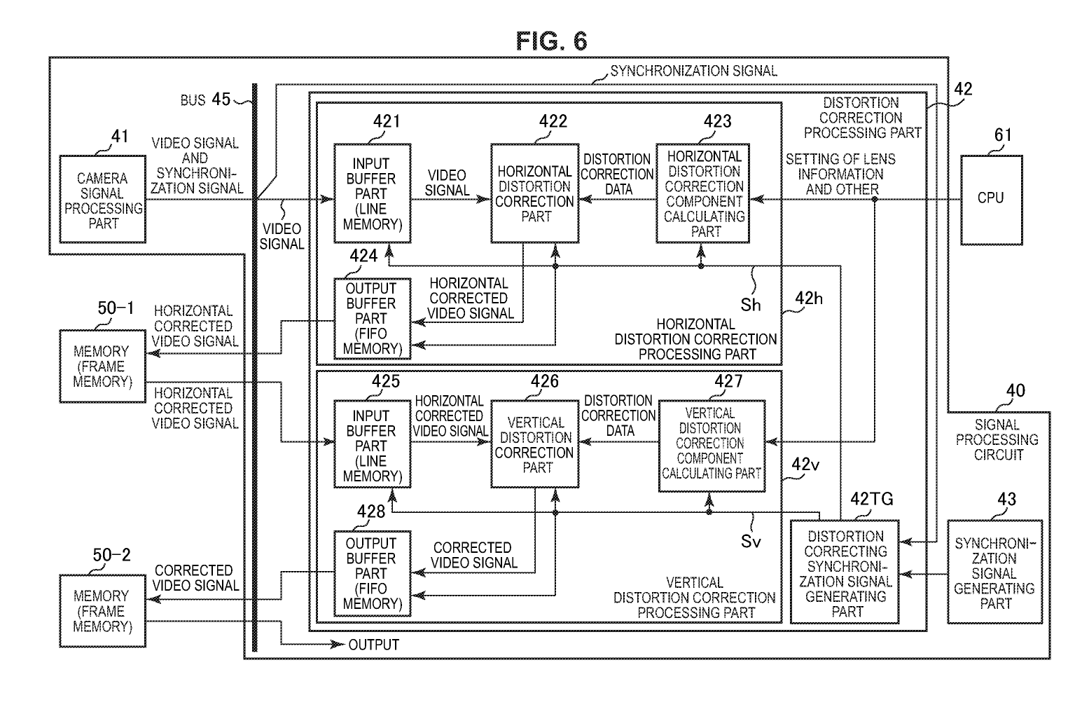

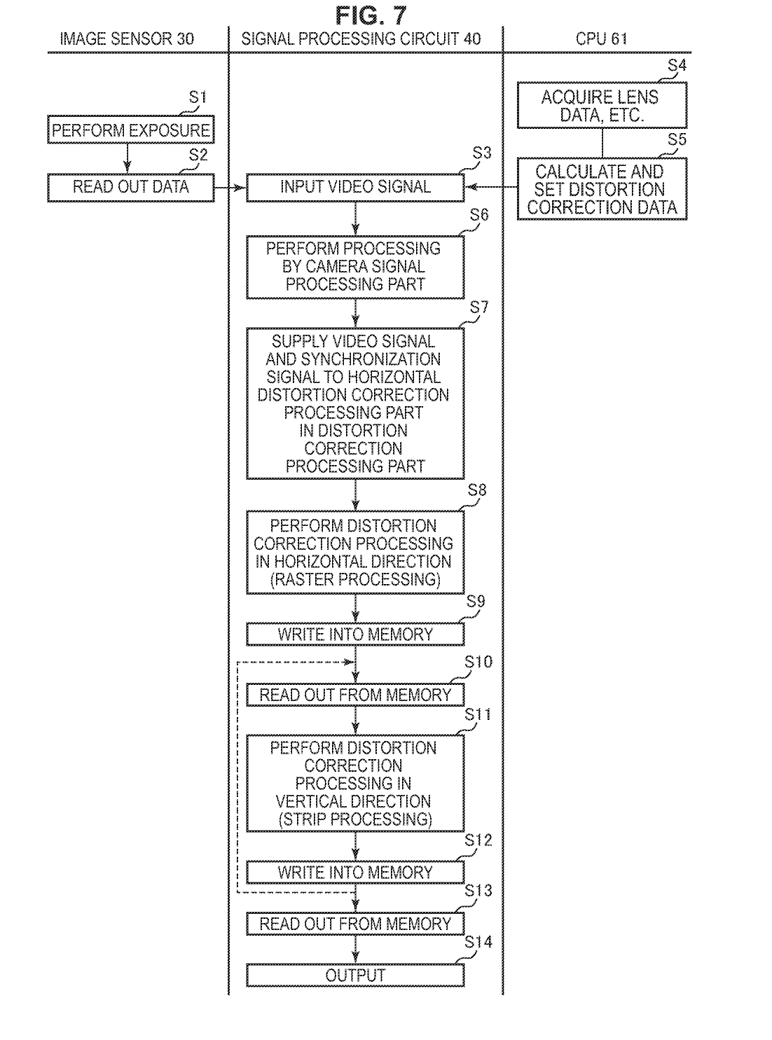

The memory 50 is a record part to write and call data output from the signal processing circuit 40. The memory 50 includes a memory 50-1 and a memory 50-2 (refer to FIG. 6) as described later.

The controlling part 60 has a CPU (central processing unit) 61, a ROM (Read Only Memory) 62 for storing a program and the like the CPU 61 executes, and a RAM (Random Access Memory) 63 used as a work area for the CPU 61, for example. Here, as the ROM 62, an electrically erasable programmable ROM is used for example. The CPU 61 is coupled with the image sensor 30, signal processing circuit 40, and memory 50 in the imaging apparatus 10 via the bus 45, for example, to control the respective blocks. The CPU 61 operates in accordance with the clock signal supplied from the outside.

### [Distortion Correction Processing Part]

FIG. 6 is a block diagram showing an example internal configuration of the distortion correction processing part 42 in the signal processing circuit 40 shown in FIG. 5.

The distortion correction processing part 42 includes a horizontal distortion correction processing part 42h performing the distortion correction processing in the horizontal direction, a vertical distortion correction processing part 42v performing the distortion correction processing in the vertical direction, and a distortion correcting synchronization signal generating part 42TG.

The horizontal distortion correction processing part 42h includes an input buffer part 421, a horizontal distortion correction part 422, a horizontal distortion correction component calculating part 423, and an output buffer part 424.

The vertical distortion correction processing part 42v includes an input buffer part 425, a vertical distortion correction part 426, a vertical distortion correction component calculating part 427, and an output buffer part 428.

The distortion correcting synchronization signal generating part 42TG is supplied with the synchronization signal from the camera signal processing part 41 and the synchronization signal generating part 43. The distortion correcting synchronization signal generating part 42TG generates a synchronization signal Sh for distortion correction processing in the horizontal direction on the basis of the synchronization signal supplied from the camera signal processing part 41 to supply the generated signal to each block in the horizontal distortion correction processing part 42h. In addition, the generating part 42TG generates a synchronization signal Sy for distortion correction processing in the vertical direction on the basis of the synchronization signal supplied from the synchronization signal generating part 43 to supply the generated signal to each block in the vertical distortion correction processing part 42v.

In this embodiment, the synchronization signal Sv for distortion correction processing in the vertical direction is delayed by a predetermined time period less than one frame as compared with the synchronization signal Sh for distortion correction processing in the horizontal direction. In accordance with these synchronization signals Sh and Sv for distortion correction processing in the horizontal direction and the vertical direction, each block is processed in the horizontal distortion correction processing part 42h and the vertical distortion correction processing part 42v.

### (Horizontal Distortion Correction Processing Part)

Hereinafter, a description will be given of the horizontal distortion correction processing part 42h.

The input buffer part 421 receives data of the video signal of one horizontal line in the image 1 from the camera signal processing part 41 and temporally stores the received data in a line memory provided therein. The input buffer part 421 sequentially outputs pixels data of the respective rows in the image relating to the video signal temporally stored in the line memory to the horizontal distortion correction part 422 depending on the synchronization signal Sh for horizontal distortion correction processing supplied from the distortion correcting synchronization signal generating part 42TG. Here, an order or the like of the pixel data sequentially output from the camera signal processing part 41 may be varied because of a large amount of the data streaming through the bus 45 and so on. Such a variation may be absorbed by virtue of the line memory provided in the input buffer part 421 such that the pixel data is output from the input buffer part 421 to the horizontal distortion correction part 422 in the predetermined order.

The horizontal distortion correction part 422 performs a horizontal distortion correction processing (raster processing) on the video signal of one frame supplied from the input buffer part 421 depending on the synchronization signal Sh for horizontal distortion correction processing on the basis of distortion correction data of the respective pixels in the horizontal direction (horizontal distortion correction data) supplied from the horizontal distortion correction component calculating part 423. The horizontal distortion correction processing by the horizontal distortion correction part 422 is performed on the respective pixels from the top row 2U-1 to the bottom row 2L-n in the image 1 to be corrected (refer to FIG. 3A), and the result thereof is sequentially output to the output buffer part 424. The horizontal distortion correction data is a parameter indicating a correction amount in the horizontal direction at pixel points constituting an original image which has distortion.

The horizontal distortion correction component calculating part 423 acquires lens information of the imaging lens 20 and other setting information supplied from the CPU 61 depending on the synchronization signal Sh for horizontal distortion correction processing, and temporally stores and sets the information in a storage part such as a register provided therein. Then, the horizontal distortion correction component calculating part 423 generates the horizontal distortion correction data for each one pixel on the basis of the information stored in the storage part provided therein to supply the generated data to the horizontal distortion correction part 422.

The lens information is the distortion correction data, for example, at a grid point obtained by dividing the image 1 in the vertical direction and the horizontal direction, and is gotten from the distortion aberration characteristics of the imaging lens 20 and a zoom position of the imaging lens 20 at a certain moment. Generally, in an optical zoom function, when the imaging lens 20 moves in a wide direction, barrel distortion occurs in the image, and when the imaging lens 20 moves in a telephoto direction, pincushion distortion occurs in the image. The distortion correction data is stored in the storage part such as the register or ROM 62 in the CPU 61, for example, as a table in which the grid point on the image 1 is associated with the distortion correction data (correction value) in the horizontal direction and the vertical direction. For example, if an image having 2048 pixels in the horizontal direction and 1080 pixels in the vertical direction is divided into ten equal portions in the respective directions, the grid points exist at every 200 pixels in the horizontal direction and at every 100 pixels in the vertical direction.

Here, other setting information supplied from the CPU 61 includes a region to be corrected in the image 1 and the like. The distortion correction processing part 42 performs the distortion correction processing in the horizontal direction and the vertical direction on a region of the image 1 specified by the CPU 61.

The horizontal distortion correction component calculating part 423 decides a pixel to be corrected on the basis of the synchronization signal Sh for horizontal distortion correction processing. Then, the part 423 reads out, for a grid point at the same as or in the vicinity of a position of this pixel, from the table the distortion correction data in the horizontal direction (correction value) to calculate the horizontal distortion correction data at the relevant pixel.

The output buffer part 424 is a FIFO (First-In First-Out) memory. The output buffer part 424 receives a horizontal corrected video signal subjected to the horizontal distortion correction processing in the horizontal distortion correction part 422 depending on the synchronization signal Sh for horizontal distortion correction processing, and writes the horizontal corrected video signal into the memory 50-1 after a buffer processing.

The memory 50-1 may be constituted by a frame memory having a predetermined capacity. From the memory 50-1, the horizontal corrected video signal is read out with a predetermined pixel width in the vertical direction depending on the synchronization signal Sv for vertical distortion correction processing.

### (Vertical Distortion Correction Processing Part)

Hereinafter, a description will be given of the vertical distortion correction processing part 42v.

The input buffer part 425 reads out the horizontal corrected video signal from the memory 50-1 depending on the synchronization signal Sv for vertical distortion correction processing supplied from the distortion correcting synchronization signal generating part 42TG, and temporally stores the read out signal in a line memory provided therein. The input buffer part 425 may have a capacity so long as the data of the minimum number of lines can be stored which is desirable for achieving the distortion correction processing in the vertical direction according to this embodiment. For example, the less the number of lines, the smaller the processing delay, but an effect of the vertical distortion correction also becomes smaller, and thus, the number of lines is preferably designed adequately. One line of the memory 50-1 has data of a predetermined number of pixels stored, for example, data of 128 pixels. The input buffer part 425 sequentially outputs pixels data of the respective rows in the image relating to the video signal temporally stored in the line memory to the vertical distortion correction part 426 depending on the synchronization signal Sh for horizontal distortion correction processing.

The vertical distortion correction part 426 performs a vertical distortion correction processing (strip processing) on the video signal supplied from the input buffer part 425 depending on the synchronization signal Sv for vertical distortion correction processing on the basis of distortion correction data of the respective pixels in the vertical direction (vertical distortion correction data) supplied from the vertical distortion correction component calculating part 427. The vertical distortion correction data is a parameter indicating a correction amount in the vertical direction at pixel points constituting an original image which has distortion.

The vertical distortion correction component calculating part 427 acquires lens information of the imaging lens 20 (table used for distortion correction) and other setting information supplied from the CPU 61 depending on the synchronization signal Sv for vertical distortion correction processing, and temporally stores and sets the information in a storage part such as a register provided therein. Then, the vertical distortion correction component calculating part 427 generates the vertical distortion correction data for each one pixel on the basis of the information stored in the storage part provided therein to supply the generated data to the vertical distortion correction part 426. Similar to the case of the horizontal distortion correction processing, the vertical distortion correction component calculating part 427 decides a pixel to be corrected on the basis of the synchronization signal Sv for vertical distortion correction processing. Then, the part 427 reads out, for a grid point at the same as or in the vicinity of a position of this pixel, from the table the distortion correction data in the vertical direction (correction value) to calculate the vertical distortion correction data at the relevant pixel.

The output buffer part 428 is a FIFO (First-In First-Out) memory. The output buffer part 428 receives a video signal (corrected video signal) subjected to the vertical distortion correction processing in the vertical distortion correction part 426 depending on the vertical synchronization signal Sy for distortion correction processing, and writes the this corrected video signal into the memory 50-2 after a buffer processing.

The memory 50-2 may be constituted by a frame memory having a predetermined capacity. The data of the video signal stored in the memory 50-2 is read out in a unit of frame depending on the synchronization signal of the main body of the imaging apparatus 10 and supplied to the display system processing part 44.

Next, a description will be given of the distortion correction processing by the signal processing circuit 40 configured as above with reference to FIG. 7.

FIG. 7 is a flowchart showing a distortion correction processing according to one embodiment of the present disclosure.

First, the CPU 61 (refer to FIG. 5) performs exposure on the respective pixels in the image sensor 30 depending on the synchronization signal of the main body of the imaging apparatus 10 in accordance with press of a shutter button or video recording button not shown or other control signal instructing image shooting (step S1). Then, the image sensor 30 reads out the pixel data from each pixel (step S2). After that, the video signals (image) based on the pixel data read out from the respective pixels of the image sensor 30 are input to the signal processing circuit 40 (step S3).

In parallel with this processing, the CPU 61 acquires lens data (distortion aberration characteristics, zoom position and the like) of the imaging lens 20 (step S4) to calculate and set the distortion correction data (step S5). Then, the CPU 61 supplies a table including the calculated distortion correction data (correction value) to the horizontal distortion correction processing part 42h and the vertical distortion correction processing part 42v (refer to FIG. 6) (step S3).

Next, the camera signal processing part 41 in the signal processing circuit 40 performs a predetermined signal processing on the input video signal (image) (step S6). Then, the camera signal processing part 41 supplies the video signal subjected to the predetermined signal processing to the horizontal distortion correction processing part 42h (input buffer part 421) in the distortion correction processing part 42, and supplies the above synchronization signal to the distortion correcting synchronization signal generating part 42TG in the distortion correction processing part 42 (step S7).

Subsequently, the horizontal distortion correction component calculating part 423 in the horizontal distortion correction processing part 42h stores the lens information (table used for the distortion correction) and other setting information supplied from the CPU 61 in the storage part such as a register depending on the synchronization signal Sv for horizontal distortion correction processing supplied from the distortion correcting synchronization signal generating part 42TG. Then, part 423 calculates and sets the distortion correction data for each one pixel used for the distortion correction processing in the horizontal direction on the basis of the lens information and other setting information. Similarly, the vertical distortion correction component calculating part 427 in the vertical distortion correction processing part 42v stores the lens information and other setting information supplied from the CPU 61 in the storage part such as a register depending on the synchronization signal Sv for vertical distortion correction processing supplied from the distortion correcting synchronization signal generating part 42TG with being delayed from the synchronization signal Sh by a predetermined time period less than one frame. Then, the part 427 calculates and sets the distortion correction data for each one pixel used for the distortion correction processing in the vertical direction (step S7).

Next, the horizontal distortion correction part 422 performs the horizontal distortion correction processing (raster processing) on the video signal of one frame supplied from the input buffer part 421 depending on the synchronization signal Sh for horizontal distortion correction processing on the basis of the horizontal distortion correction data of the respective pixels supplied from the horizontal distortion correction component calculating part 423 (step S8). The corrected result thereof (data of the horizontal corrected video signal) is sequentially output to the output buffer part 424. This horizontal distortion correction processing by the horizontal distortion correction part 422 is performed until the processing on all pixels of the image is completed using the video signal of one frame.

The output buffer part 424 sequentially writes the horizontal corrected video signal input from the horizontal distortion correction part 422 into the memory 50-1 depending on the synchronization signal Sh for horizontal distortion correction processing (step S9).

The input buffer part 425 in the vertical distortion correction processing part 42v reads out the data of the horizontal corrected video signal from the memory 50-1 depending on the synchronization signal Sv for vertical distortion correction processing and supplies the data to the vertical distortion correction part 426 (step S10). This synchronization signal for vertical distortion correction processing Sv is supplied to the input buffer part 425 at the completion of the distortion correction processing in the horizontal direction on one region of a plurality of regions which are obtained by dividing the input image in the vertical direction.

The vertical distortion correction part 426 performs the vertical distortion correction processing (strip processing) on the video signal of the above one region of the input image supplied from the input buffer part 425 on the basis of the distortion correction data supplied from the vertical distortion correction component calculating part 427 depending on the synchronization signal Sv for vertical distortion correction processing (step S11). During this vertical distortion correction processing, the horizontal distortion correction processing is being performed by the horizontal distortion correction processing part 42h on a region adjacent to the above one region depending on the synchronization signal Sh for horizontal distortion correction processing.

The output buffer part 428 sequentially writes the data of the corrected video signal for the above one region in the input image input from vertical distortion correction part 426 into the memory 50-2 depending on the synchronization signal Sv for vertical distortion correction processing (step S12).

Here, if the horizontal distortion correction processing is completed on the region adjacent to the one region in the input image, the process proceeds to step S10, and the vertical distortion correction processing is performed on the region adjacent to the relevant one region by the vertical distortion correction part 426.

After the vertical distortion correction processing is performed on all the regions in the input image, that is, all pixels, the corrected video signal is read out from the memory 50-2 (step S13) to be output to the display system processing part 44, for example (step S14).

### [Timing of Vertical Distortion Correction Processing]

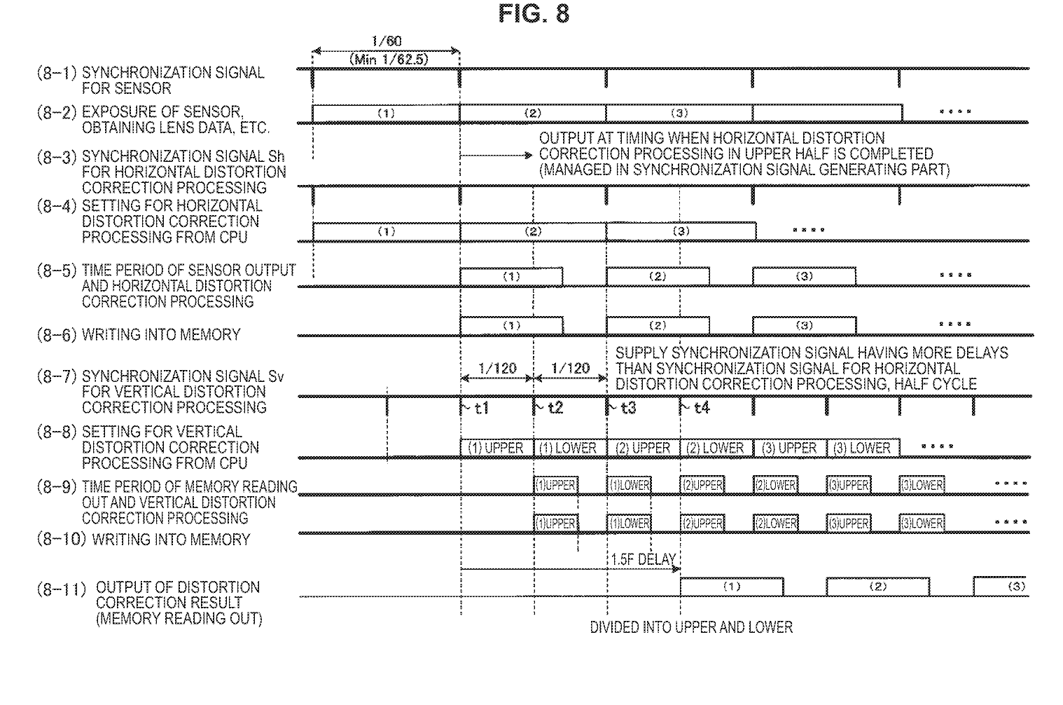

FIG. 8 is a timing chart of a distortion correction processing according to one embodiment of the present disclosure (refer to FIG. 3). Here, in this example, a start timing of the vertical distortion correction processing is not at the completion of the horizontal distortion correction processing but at a timing depending on the synchronization signal Sy for vertical distortion correction processing after the completion of the horizontal distortion correction processing.

For example, exposure of the image sensor 30 is performed depending on the synchronization signal (8-1) for the image sensor 30 with a period of 1/60 ( 1/62.5 in the shortest) second per cycle. Moreover, the CPU 61 acquires the lens information of the imaging lens 20 (table used for the distortion correction) and the like (8-2). In the example shown in FIG. 8, time periods associated with first to third images sequentially output from the image sensor 30 are presented by (1), (2), and (3).

After the exposure of the image sensor 30 and the acquisition of the lens information and the like by the CPU 61, the horizontal distortion correction processing part 42h in the distortion correction processing part 42, depending on the synchronization signal Sh (8-3) for horizontal distortion correction processing, receives from the CPU 61 and sets the distortion correction data for horizontal distortion correction processing (8-4). After that, an image is output from the image sensor 30, the respective pixels of which image are sequentially subjected to the horizontal distortion correction processing depending on the synchronization signal Sh for horizontal distortion correction processing (8-5), and the image subjected to the horizontal distortion correction processing (horizontal-corrected image) is written into the memory 50-1 (8-6).

At this time, as shown in FIG. 3A, the distortion correction processing in the horizontal direction is performed on the image 1 to be corrected from the top row 2U-1 to the bottom row 2L-n, and the result thereof is accumulated in the memory 50-1 depending on the synchronization signal Sh for horizontal distortion correction processing. Then, during the distortion correction processing on the above image 1 in a unit of pixel row, at the completion of the distortion correction processing in the horizontal direction on, besides on the first region as the upper half of the image 1, a row belonging to the second region and continuous to the first region, immediately after thereof, the distortion correction processing in the vertical direction is started on the first region depending on the synchronization signal Sv for vertical distortion correction processing.

After the completion of the horizontal distortion correction processing on the first region of the image 1, depending on the synchronization signal Sv (8-7) for vertical distortion correction processing, the vertical distortion correction processing part 42v receives from the CPU 61 and sets the distortion correction data of the vertical distortion correction processing (8-8). Here, at a timing (time t1) when the setting of the distortion correction data of the horizontal distortion correction processing is finished and the horizontal distortion correction processing is started, setting of the distortion correction data of the vertical distortion correction processing is started. The distortion correction data of the vertical distortion correction processing is set for the first region and the second region respectively. This synchronization signal Sv for vertical distortion correction processing is a synchronization signal delayed from the synchronization signal for horizontal distortion correction processing, and a period per cycle is half for the synchronization signal for horizontal distortion correction processing ( 1/120 second in this example).

After one period per cycle (time t2) from the above, the memory 50-1 is sequentially read out in the vertical direction from the pixel group 3U-1 to the pixel group 3L-n and the 3U-m depending on the synchronization signal Sv for vertical distortion correction processing to perform the vertical distortion correction processing, the pixel group 3U-1 being in the top row 2U-1 in the horizontal-corrected image for the first region of the image 1, the pixel group 3L-n being in the bottom row 2L-n, and the 3U-m being in the row 2U-m lower than the bottom row 2U-n by one row.

Further, at the completion of the distortion correction processing in the horizontal direction on the second region as the lower half of the image 1, immediately after thereof, the distortion correction processing in the vertical direction is started on the second region depending on the synchronization signal Sv for vertical distortion correction processing. In other words, after one period per cycle from the time t2 (time t3), the memory 50-1 is sequentially read out in the vertical direction from the pixel group 3L-m and the pixel group 3L-1 to the pixel group 3L-n to perform the vertical distortion correction processing (8-9), the pixel group 3L-m being in the row 2U-n upper than the top row 2L-1 by one row in the horizontal-corrected image for the second region of the image 1, the pixel group 3L-1 being in the top row 2L-1 in the second region, and the pixel group 3L-n being in the bottom row 2L-n.

The corrected image obtained by performing the vertical distortion correction processing on the first region of the image 1 and the corrected image obtained by performing the vertical distortion correction processing on the second region of the image 1 are sequentially written into the memory 50-2 depending on the synchronization signal Sv for vertical distortion correction processing (8-10).

After that, the vertical distortion correction processing part 42v reads out the corrected image from the memory 50-2 after one period per cycle (time t4) from the start timing of the vertical distortion correction processing on the second region depending on the synchronization signal Sv for vertical distortion correction processing, and output the read image to the display system processing part 44 (8-11).

Such a series of the distortion correction processing by the distortion correction processing part 42 is sequentially performed on a second image, a third image and so on following the first image.

The above described embodiment has a configuration in which the input image is divided into two equal potions in the vertical direction, and at to completion of the horizontal distortion correction processing on an upper side region, the vertical distortion correction processing is started on the upper side region. In other words, after starting the horizontal distortion correction processing, the vertical distortion correction processing is started with being delayed by a predetermined time period less than one frame (½ frame in the above example). According to the above, the vertical distortion correction processing can be started before the completion of the horizontal distortion correction processing on the entire input image. As a result, it is possible as compared with the related art to decrease a delay generated from the start of the time period of the horizontal distortion correction processing until the vertical distortion correction processing is completed to obtain the corrected image. For example, if the vertical distortion correction processing is started on the upper side region at a time of the completion of the horizontal distortion correction processing on the upper side region of the input image, it is possible to suppress the delay to a time of about 1.5 frame which is generated from the start of the time period of the horizontal distortion correction processing until the vertical distortion correction processing is completed to obtain the corrected image.

In addition, this embodiment may have a capacity so long as the data of the minimum number of lines can be stored which is desirable for achieving the distortion correction processing in the vertical direction, and thus many line memories are not necessary.

If time taken for the horizontal distortion correction processing on, besides on the first region of input image, a portion which is duplicatively processed in the first region and the second regions is shorter than half the vertical synchronization signal, as shown in FIG. 4, a period per cycle for the start of the vertical distortion correction processing may be set half the period per cycle for the start of the horizontal distortion correction processing. In this case, the completion of the horizontal distortion correction processing on the first region may not be confirmed, which leads to the simplified processing, suppressing the circuit to a small size.

### <2. Others>

Here, the above embodiment describes the example in which the input image is divided in the vertical direction into two equal potions (refer to FIG. 3 and FIG. 4), but, may not be divided into two equal portions. For example, the input image may be divided in the vertical direction into three or more equal regions. At every completion of the distortion correction processing in the horizontal direction on each region of a plurality of regions which are obtained by divining the input image, the distortion correction processing in the vertical direction is started on the region on which the relevant distortion correction processing in the horizontal direction has been completed.

For example, if the input image is divided in the vertical direction into two equal portions, a distortion in a center portion of the image can be accurately corrected.

Moreover, if the input image is divided in the vertical direction into three or more equal portions, higher speed processing is enabled as compared with the two-equal divide, but, increase of the portions duplicatively processed in the plural divided regions increases the number of pixels to be processed. However, if under an imaging lens, image shooting condition and environment with a large distortion, the input image may be accurately corrected.

Additionally, the above embodiment describes the example in which the image is divided in the vertical direction into two equal potions (refer to FIG. 3 and FIG. 4), but may not be divided into equal portions. For example, if the image is divided in the vertical direction into two portions, the image may be unequally divided such that the upper side region may be a region of one-third of the entire image, the lower side region may be a region of two-third of the entire image, and so on.

However, one region preferably has a size of one-third or more of the entire image in terms of a balance among the high speed processing, the number of pixels to be processed, and distortion correction accuracy.

Further, the above embodiment describes the example in which data of the predetermined number of pixels (128 pixels, for example) is stored in the line memory in the input buffer part 425 to perform the strip processing in the vertical distortion correction processing, but is not limited to this example. If the line memory in the input buffer part 425 is not restricted, a configuration may be in which data of one pixel is stored in one line. In this case, a finer vertical distortion correction processing can be performed, but an amount of data is increased for an address of the pixel where the vertical distortion correction processing is started, for example. Rather than the vertical distortion correction processing in a unit of one pixel or a unit of small numbers of pixels, the vertical distortion correction processing in a unit of some certain numbers of pixels may be performed with a better processing efficiency and a higher processing speed.

Furthermore, an image to be distortion correction-processed includes not only the image output from the image sensor 30 but also an image output from the image sensor 30 and temporally stored in a storage medium such as a flash memory, an image received from the outside and stored in the storage medium, and the like. Here, the memory 50 may be used as the storage medium in this case.

Moreover, the above embodiment illustrates the configuration in which the synchronization signal Sh for horizontal distortion correction processing is generated on the basis of the synchronization signal supplied from the camera signal processing part 41, and synchronization signal Sv for vertical distortion correction processing is generated on the basis of the synchronization signal supplied from the synchronization signal generating part 43 (refer to FIG. 6 and FIG. 8). However, the embodiment is not limited to this configuration. For example, the synchronization signal Sh for horizontal distortion correction processing and the synchronization signal Sv for vertical distortion correction processing which is delayed from and has a period per cycle half for this synchronization signal Sh may be generated on the basis of the synchronization signal supplied from the synchronization signal generating part 43. For example, if the distortion correction is performed on the image stored in the storage medium, the synchronization signal output from the image sensor 30 is difficult to use, but the configuration like this makes it possible to use the synchronization signal supplied from the synchronization signal generating part 43 to perform the vertical distortion correction processing and the horizontal distortion correction processing.

Further, as other setting information supplied from the CPU 61 to the distortion correction processing part 42 in the above embodiment, setting information for a camera shake correction function may be given.

In addition, the above described embodiment may be applicable to the distortion correction for an image distortion due to the rolling shutter system. In this case, the grid point on the image and the distortion correction data for correcting the distortion in the horizontal direction and the vertical direction due to the rolling shutter system may be registered with being associated with each other in a table for distortion correction supplied from the CPU 61. Additionally, the distortion correction data which reflects both a correction amount for a distortion due to the imaging lens and a correction amount for a distortion due to the rolling shutter system may be registered in the table with being associated with the grid point on the image. This makes it possible to correct together the distortion due to the imaging lens and the distortion due to the rolling shutter system.

Moreover, the above embodiment describes the example in which the imaging lens 20 is attached to the main body of the imaging apparatus 10, but the imaging lens 20 may be detachable to the main body of the imaging apparatus 10.

Additionally, the present technology may also be configured as below.
(1) An image processing apparatus including:

a horizontal distortion correction processing part configured to perform a distortion correction processing in a horizontal direction on an input image depending on a synchronization signal that is supplied;

a memory configured to sequentially store results of the distortion correction processing in the horizontal direction by the horizontal distortion correction processing part; and

a vertical distortion correction processing part configured to, after starting the distortion correction processing in the horizontal direction by the horizontal distortion correction processing part, sequentially read out the results of the distortion correction processing in the horizontal direction from the memory with a delay of a predetermined time period less than one frame to start a distortion correction processing in a vertical direction.
(2) The image processing apparatus according to (1), wherein

the vertical distortion correction processing part starts, at every completion of the distortion correction processing in the horizontal direction by the horizontal distortion correction processing part on each region of a plurality of regions which are obtained by dividing the input image in the vertical direction, the distortion correction processing in the vertical direction on the region on which the distortion correction processing in the horizontal direction has been completed.
(3) The image processing apparatus according to (2), wherein

each of the plurality of regions has a size of one-third or more of a whole of the input image.
(4) The image processing apparatus according to (2) or (3), wherein

the vertical distortion correction processing part starts, after completion of the distortion correction processing in the horizontal direction by the horizontal distortion correction processing part on a first region of regions obtained by dividing the input image into two equal regions in the vertical direction, the distortion correction processing in the vertical direction on the first region in the input image.
(5) The image processing apparatus according to any one of (2) to (4), wherein

the horizontal distortion correction processing part performs the distortion correction processing in the horizontal direction on one region in the input image as well as a portion including a predetermined number of horizontal lines included in a region which is continuous to the one region and adjacent to the one region, and

the vertical distortion correction processing part performs the distortion correction processing in the vertical direction on the one region in the input image having been subjected to the distortion correction processing in the horizontal direction and a correction processing input image including the predetermined number of horizontal lines to output the one region in the input image subjected to the distortion correction processing in the vertical direction as a correction processing output image.
(6) An imaging apparatus including:

an image sensor;

a horizontal distortion correction processing part configured to perform a distortion correction processing in a horizontal direction on an input image from the image sensor depending on a synchronization signal that is supplied;

a memory configured to sequentially store results of the distortion correction processing in the horizontal direction by the horizontal distortion correction processing part; and

a vertical distortion correction processing part configured to, after starting the distortion correction processing in the horizontal direction by the horizontal distortion correction processing part, sequentially read out the results of the distortion correction processing in the horizontal direction from the memory with a delay of a predetermined time period less than one frame to start a distortion correction processing in a vertical direction.
(7) An image processing method including:

performing a distortion correction processing in a horizontal direction on an input image depending on a synchronization signal that is supplied, by a horizontal distortion correction processing part included in an image processing apparatus;

sequentially storing, in a memory, results of the distortion correction processing in the horizontal direction by the horizontal distortion correction processing part, by the horizontal distortion correction processing part; and

sequentially reading out, after starting the distortion correction processing in the horizontal direction by the horizontal distortion correction processing part, the results of the distortion correction processing in the horizontal direction from the memory with a delay of a predetermined time period less than one frame to start a distortion correction processing in a vertical direction, by a vertical distortion correction processing part included in the image processing apparatus.
(8) A program causing a computer to execute the procedures of:

performing a distortion correction processing in a horizontal direction on an input image depending on a synchronization signal that is supplied;

sequentially storing, in a memory, results of the distortion correction processing in the horizontal direction; and

sequentially reading out, after starting the distortion correction processing in the horizontal direction, the results of the distortion correction processing in the horizontal direction from the memory with a delay of a predetermined time period less than one frame to start a distortion correction processing in a vertical direction.

### [Example in the Scope of the Present Disclosure]

Here, as described above, the imaging apparatus 10 in FIG. 5 performs an image processing for extracting a structure of the image from a broad perspective. Information extracted by such an image processing can be used for processing to improve an image quality and the like, and thus, the apparatus 10 can be applied to not only a digital video camera but also other apparatuses, as an apparatus implementing a block for extracting the structure of the image from a broad perspective. For example, that kind of apparatus possibly includes an imaging apparatus such as the digital still camera, a printer, a display device such as a display, and the like. Further, the apparatus 10 can also applied to an apparatus and computer program for fabricating or editing the image.

### [Example of Hardware Configuration of Computer]

Note that the series of processing described above can be executed by hardware and can also be executed by software. If the series of processing is executed by software, a program that constructs the software is installed from a program recording medium into a computer incorporated in dedicated hardware or a general-purpose personal computer or the like which is capable of executing various functions by having various programs installed.

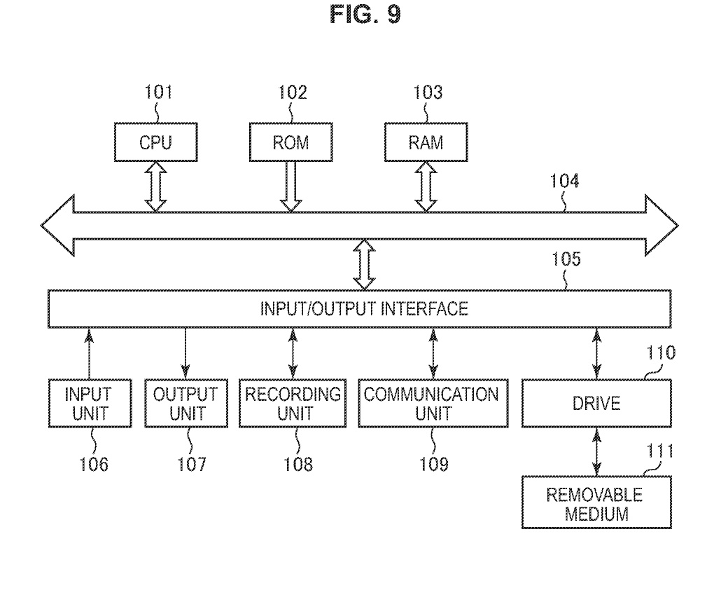

FIG. 9 is a block diagram showing an example hardware configuration of a computer that executes the series of processing described earlier according to a program.

In this computer, a CPU 101, a ROM (Read Only Memory) 102, and a RAM 103 are connected to one another by a bus 104.

An input/output interface 105 is also connected to the bus 104. An input unit 106 composed of a keyboard, a mouse, a microphone, or the like, an output unit 107 composed of a display, speakers, and the like, a recording unit 108 composed of a hard disk drive, a nonvolatile memory, or the like, a communication unit 109 composed of a network interface or the like, and a drive 110 that drives a removable medium 111 such as a magnetic disk, an optical disc, a magneto-optical disc, or a semiconductor memory are connected to the input/output interface 105.

In the computer configured as described above, as one example the CPU 101 loads a program recorded in the recording unit 108 via the input/output interface 105 and the bus 104 into the RAM 103 and executes the program to carry out the series of processing described earlier.

The program executed by the computer (CPU 101) is recorded on a removable medium 111 that is a packaged medium composed for example of a magnetic disk (including a flexible disk), an optical disc (such as a CD-ROM (Compact Disc-Read Only Memory) or a DVD (Digital Versatile Disc)), a magneto-optical disc, or a semiconductor memory, or is provided via a wired or wireless transfer medium such as a local area network, the Internet, or a digital satellite broadcast.

After this, by loading the removable medium 111 into the drive 110, the program can be installed via the input/output interface 105 into the recording unit 108. It is also possible to receive the program via a wired or wireless transfer medium using the communication unit 109 and install the program into the recording unit 108. As an alternative, it is also possible to install the program in advance into the ROM 102 or the recording unit 108.

It should be noted that the program executed by a computer may be a program that is processed in a time series according to the sequence described in this specification or a program that is processed in parallel or at necessary timing such as upon calling.

It should be understood by those skilled in the art that various modifications, combinations, sub-combinations and alterations may occur depending on design requirements and other factors insofar as they are within the scope of the appended claims or the equivalents thereof.

In other words, the example in the above described each embodiment is a preferable specific example of the present disclosure, and thus, has various limits technically preferable. However, the technical scope of the present disclosure is not limited by these embodiments unless limitation on the present disclosure is specifically described in each description. For example, a material used and an amount used therefor, a processing time, an order of processing, and a numerical condition for each parameter which are cited in the above description are only preferable examples, and a size, shape and arrangement relationship in the drawing used in the description are schematically described.

What is claimed is:

1. An image processing apparatus comprising:
a horizontal distortion correction processing part configured to perform a distortion correction processing in a horizontal direction on an input image depending on a synchronization signal that is supplied;
a memory configured to sequentially store results of the distortion correction processing in the horizontal direction by the horizontal distortion correction processing part; and
a vertical distortion correction processing part configured to, after starting the distortion correction processing in the horizontal direction by the horizontal distortion correction processing part, sequentially read out the results of the distortion correction processing in the horizontal direction from the memory with a delay of a predetermined time period less than one frame to start a distortion correction processing in a vertical direction.

2. The image processing apparatus according to claim 1, wherein
the vertical distortion correction processing part starts, at every completion of the distortion correction processing in the horizontal direction by the horizontal distortion correction processing part on each region of a plurality of regions which are obtained by dividing the input image in the vertical direction, the distortion correction processing in the vertical direction on the region on which the distortion correction processing in the horizontal direction has been completed.

3. The image processing apparatus according to claim 2, wherein
each of the plurality of regions has a size of one-third or more of a whole of the input image.

4. The image processing apparatus according to claim 3, wherein
the vertical distortion correction processing part starts, after completion of the distortion correction processing in the horizontal direction by the horizontal distortion correction processing part on a first region of regions obtained by dividing the input image into two equal regions in the vertical direction, the distortion correction processing in the vertical direction on the first region in the input image.

5. The image processing apparatus according to claim 2, wherein
the horizontal distortion correction processing part performs the distortion correction processing in the horizontal direction on one region in the input image as well as a portion including a predetermined number of horizontal lines included in a region which is continuous to the one region and adjacent to the one region, and
the vertical distortion correction processing part performs the distortion correction processing in the vertical direction on the one region in the input image having been subjected to the distortion correction processing in the horizontal direction and a correction processing input image including the predetermined number of horizontal lines to output the one region in the input image subjected to the distortion correction processing in the vertical direction as a correction processing output image.

6. An imaging apparatus comprising:
an image sensor;
a horizontal distortion correction processing part configured to perform a distortion correction processing in a horizontal direction on an input image from the image sensor depending on a synchronization signal that is supplied;
a memory configured to sequentially store results of the distortion correction processing in the horizontal direction by the horizontal distortion correction processing part; and
a vertical distortion correction processing part configured to, after starting the distortion correction processing in the horizontal direction by the horizontal distortion correction processing part, sequentially read out the results of the distortion correction processing in the horizontal direction from the memory with a delay of a predetermined time period less than one frame to start a distortion correction processing in a vertical direction.

7. An image processing method comprising:
performing a distortion correction processing in a horizontal direction on an input image depending on a synchronization signal that is supplied, by a horizontal distortion correction processing part included in an image processing apparatus;
sequentially storing, in a memory, results of the distortion correction processing in the horizontal direction by the horizontal distortion correction processing part, by the horizontal distortion correction processing part; and
sequentially reading out, after starting the distortion correction processing in the horizontal direction by the horizontal distortion correction processing part, the results of the distortion correction processing in the horizontal direction from the memory with a delay of a predetermined time period less than one frame to start a distortion correction processing in a vertical direction, by a vertical distortion correction processing part included in the image processing apparatus.

8. A program causing a computer to execute the procedures of:
performing a distortion correction processing in a horizontal direction on an input image depending on a synchronization signal that is supplied;
sequentially storing, in a memory, results of the distortion correction processing in the horizontal direction; and
sequentially reading out, after starting the distortion correction processing in the horizontal direction, the results of the distortion correction processing in the horizontal direction from the memory with a delay of a predetermined time period less than one frame to start a distortion correction processing in a vertical direction.
